(19) United States
(12) Patent Application Publication
(10) Pub. No.: US 2025/0112393 A1
(43) Pub. Date: Apr. 3, 2025

(54) TERMINAL AND ELECTRICAL CONNECTION ASSEMBLY

(71) Applicants: Tyco Electronics Technology (SIP) Ltd., Suzhou (CN); Tyco Electronics (Shanghai) Co., Ltd., Shanghai (CN)

(72) Inventors: Lei Pan, Shanghai (CN); Weidong Zhang, Shanghai (CN); Kai Wang, Suzhou (CN)

(73) Assignees: Tyco Electronics Technology (SIP) Ltd., Suzhou (CN); Tyco Electronics (Shanghai) Co., Ltd., Shanghai (CN)

(21) Appl. No.: 18/899,515

(22) Filed: Sep. 27, 2024

(30) Foreign Application Priority Data
Sep. 28, 2023 (CN) 202311285020.3

(51) Int. Cl. H01R 13/115; H01R 12/71

(52) U.S. Cl. CPC H01R 13/115; H01R 12/718

(57) ABSTRACT

A terminal includes a horizontal plate having a first side and a second side opposite to each other in a first horizontal direction, a first elastic arm, and a second elastic arm. A first end of the first elastic arm is connected to a first side edge of the horizontal plate and a second end of the first elastic arm is fixed to a circuit board. A first end of the second elastic arm is connected to a second side edge of the horizontal plate and a second end of the second elastic arm is fixed to the circuit board. The first elastic arm and the second elastic arm grip a mating plug inserted between them to make electrical contact with the mating plug. The horizontal plate is suspended above the circuit board by the first elastic arm and the second elastic arm.

### CROSS-REFERENCE TO RELATED APPLICATION

This application claims the benefit of the filing date under 35 U.S.C. § 119 (a)-(d) of Chinese Patent Application No. 202311285020.3, filed on Sep. 28, 2023.

### FIELD OF THE INVENTION

The present invention relates to a terminal and an electrical connection assembly comprising the terminal.

### BACKGROUND OF THE INVENTION

It is sometimes necessary to install multiple terminals simultaneously on a circuit board, with multiple mating plugs suitable for respectively inserting into the terminals to make electrical contact with the terminals. In order to insert the mating plugs into the terminals simultaneously, the installation position error of each terminal must be small or zero. However, in practical applications, there is always some error in the installation position of the terminals, making it difficult to achieve high accuracy. This leads to difficulty in multiple mating plugs being inserted into multiple terminals simultaneously, which increases difficulty in the overall mating operation of the product. In order to reduce the difficulty of mating, the installation position accuracy of terminals must be improved, but such an improvement generally leads to a sharp increase in cost.

### SUMMARY OF THE INVENTION

A terminal includes a horizontal plate having a first side and a second side opposite to each other in a first horizontal direction, a first elastic arm, and a second elastic arm. A first end of the first elastic arm is connected to a first side edge of the horizontal plate and a second end of the first elastic arm is fixed to a circuit board. A first end of the second elastic arm is connected to a second side edge of the horizontal plate and a second end of the second elastic arm is fixed to the circuit board. The first elastic arm and the second elastic arm grip a mating plug inserted between them to make electrical contact with the mating plug. The horizontal plate is suspended above the circuit board by the first elastic arm and the second elastic arm.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a terminal according to an exemplary embodiment;

FIG. 2 shows a three-dimensional sectional view of a terminal according to an exemplary embodiment;

FIG. 3 shows an illustrative plan view of a terminal according to an exemplary embodiment;

FIG. 4 shows a planar sectional view of a terminal according to an exemplary embodiment, wherein the mating plug and circuit board are shown;

FIG. 5 shows an illustrative perspective view of a terminal according to another exemplary embodiment;

FIG. 6 shows a three-dimensional sectional view of a terminal according to another exemplary embodiment;

FIG. 7 shows an illustrative plan view of a terminal according to another exemplary embodiment; and

FIG. 8 shows a planar sectional view of a terminal according to another exemplary embodiment, wherein the mating plug and circuit board are shown.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

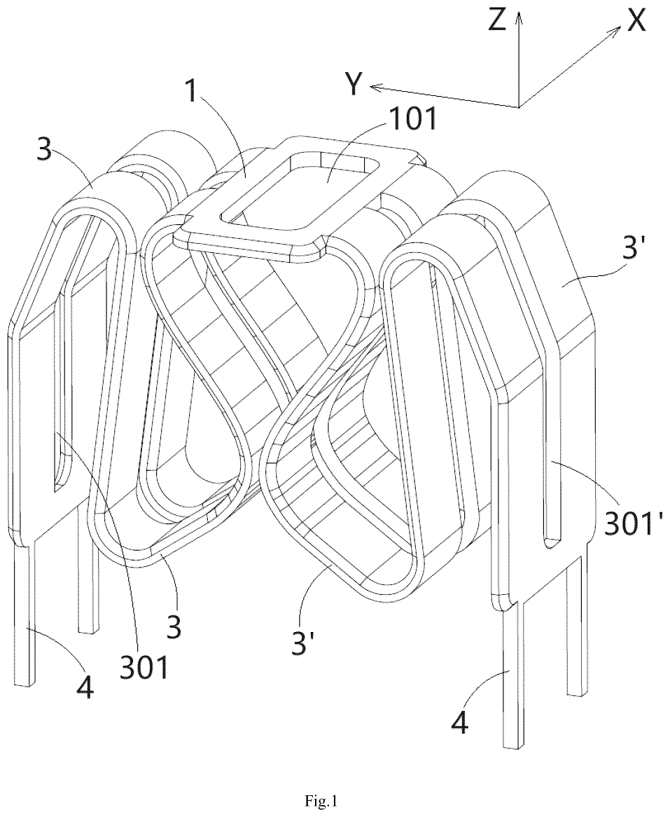

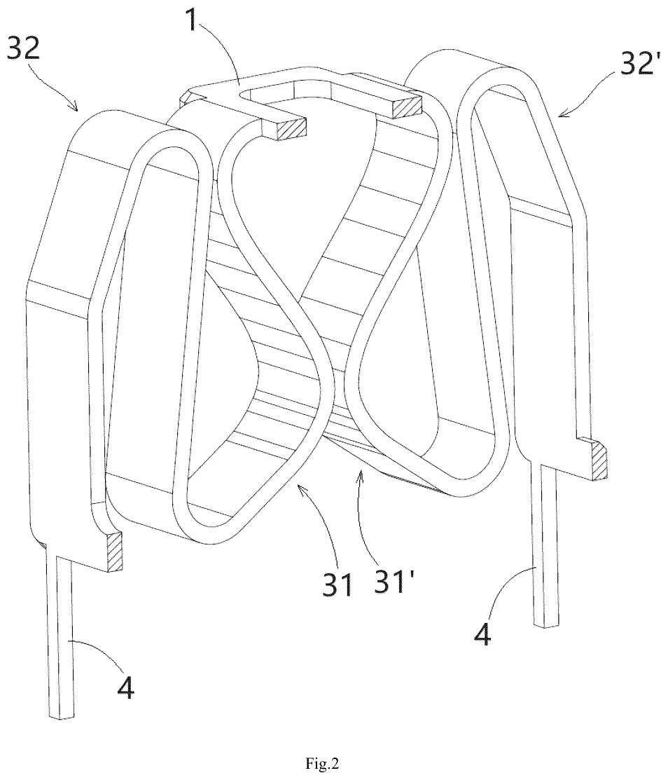

FIGS. 1 to 4 show terminals according to a first embodiment. As shown in FIGS. 1 to 4, in an exemplary embodiment of the present invention, a terminal is disclosed. The terminal includes a horizontal plate 1, a first elastic arm 3, and a second elastic arm 3′. The horizontal plate 1 has a first side edge and a second side edge that are opposite to each other in a first horizontal direction Y. One end of the first elastic arm 3 is connected to the first side edge of the horizontal plate 1, and the other end of the first elastic arm 3 is adapted to be fixed to a circuit board 6. One end of the second elastic arm 3′ is connected to the second side edge of the horizontal plate 1, and the other end of the second elastic arm 3′ is adapted to be fixed to the circuit board 6.

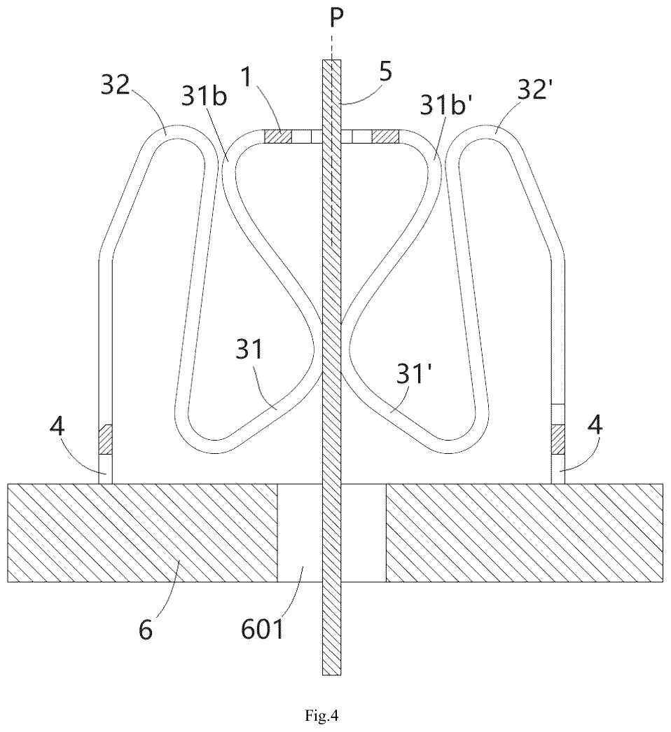

In the illustrated embodiments, the first elastic arm 3 and the second elastic arm 3′ are suitable for clamping a mating plug 5 inserted between them to make electrical contact with the mating plug 5, as shown in FIG. 4. When the other end of the first elastic arm 3 and the other end of the second elastic arm 3′ are fixed to the circuit board 6, the horizontal plate 1 is suspended above the circuit board 6 by the first elastic arm 3 and the second elastic arm 3′.

As shown in FIG. 4, in the illustrated embodiments, the terminal has a vertical symmetry plane P, which extends along a second horizontal direction X and a vertical direction Z that are perpendicular to the first horizontal direction Y. The first elastic arm 3 and the second elastic arm 3′ are symmetrically arranged at both sides of the vertical symmetry plane P.

As shown in FIGS. 1 to 4, in the illustrated embodiments, the first elastic arm 3 has a first contact arm 31, which is bent into a V-shape and one end of which is connected to the first side edge of the horizontal plate 1. The second elastic arm 3′ has a second contact arm 31′, which is bent into a V-shape and one end of which is connected to the second side edge of the horizontal plate 1. The first contact arm 31 and the second contact arm 31′ are used to clamp the inserted mating plug 5 to make electrical contact with both sides of the mating plug 5.

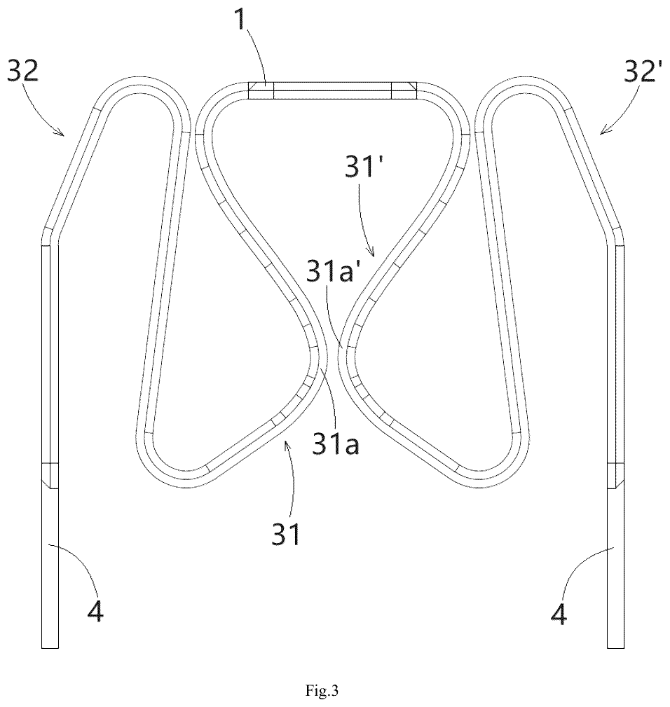

As shown in FIG. 3, in the illustrated embodiments, the first contact arm 31 has a first contact portion 31a, which is used for electrical contact with one side of the inserted mating plug 5. The second contact arm 31′ has a second contact portion 31a′, which is used for electrical contact with the other side of the inserted mating plug 5. In the illustrated embodiments, the first elastic arm 3 further includes a first connection arm 32, which is bent into a U-shaped shape and connected to the other end of the first contact arm 31. The second elastic arm 3′ includes a second connection arm 32′, which is bent into a U-shaped shape and one end of which is connected to the other end of the second contact arm 31′. The other end of the first connection arm 32 and the other end of the second connection arm 32′ are interconnected and used to connect to the circuit board 6.

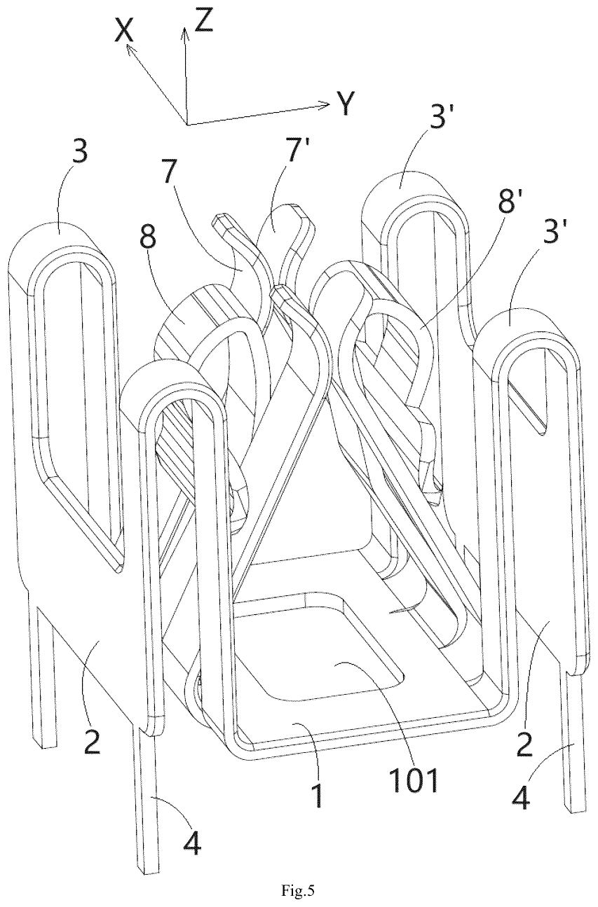

In the illustrated embodiments, when the mating plug 5 is inserted centrally (i.e. along the vertical mating plane P) between the first contact arm 31 and the second contact arm 31′ as shown in FIG. 5, the first contact arm 31 is not in contact with the first connection arm 32, and the second contact arm 31′ is not in contact with the second connection arm 32′. When the mating plug 5 is biased towards the first contact arm 31 and inserted between the first contact arm 31 and the second contact arm 31′, one end 31b (upper end in the figure) of the first contact arm 31 contacts the first connection arm 32, while the second contact arm 31′ does not contact the second connection arm 32′. At this time, the contact force between the first contact arm 31 and the mating plug 5 can be increased. Similarly, when the mating plug 5 is biased towards the second contact arm 31′ and inserted between the first contact arm 31′ and the second contact arm 31′, the first contact arm 31 does not contact the first connection arm 32, and one end 31b′ (upper end in the figure) of the second contact arm 31′ contacts the second connection arm 32′. At this time, the contact force between the second contact arm 31′ and the mating plug 5 can be increased.

The present invention is not limited to the illustrated embodiments. For example, in another exemplary embodiment of the present invention, when the mating plug 5 is not inserted between the first contact arm 31 and the second contact arm 31′, the first contact arm 31 is not in contact with the first connection arm 32, and the second contact arm 31′ is not in contact with the second connection arm 32′. When the mating plug 5 has been inserted between the first contact arm 31 and the second contact arm 31′, one end 31b of the first contact arm 31 contacts the first connection arm 32, and one end 31b′ of the second contact arm 31′ contacts the second connection arm 32′. In this way, it can increase the contact force between the first contact arm 31 and the mating plug 5, as well as the contact force between the second contact arm 31′ and the mating plug 5.

In another embodiment, when the mating plug 5 is not inserted between the first contact arm 31 and the second contact arm 31′, one end 31b of the first contact arm 31 is in contact with the first connection arm 32, and one end 31b′ of the second contact arm 31′ is in contact with the second connection arm 32′. This can increase the contact force between the first contact arm 31 and the mating plug 5, as well as the contact force between the second contact arm 31′ and the mating plug 5.

As shown in FIG. 1, in the illustrated embodiments, at least one first partition groove 301 is formed on the first elastic arm 3, and each first partition groove 301 extends from one end of the first elastic arm 3 to the other end to increase the elasticity of the first elastic arm 3. At least one second partition groove 301′ is formed on the second elastic arm 3′, and each second partition groove 301′ extends from one end of the second elastic arm 3′ to the other end to increase the elasticity of the second elastic arm 3′.

As shown in FIGS. 1 to 4, in the illustrated embodiments, the terminal further comprises multiple fixing pins 4, which are respectively formed on the other end of the first elastic arm 3 and the second elastic arm 3′ and are suitable for being respectively fixed to multiple holes in the circuit board 6 for electrical connection with the circuit board 6.

In the illustrated embodiments, one ends of the first connection arm 32 and the second connection arm 32′ and the other ends of the first connection arm 32 and the second connection arm 32′ are separated by a first distance in the first horizontal direction Y and a second distance in the vertical direction Z perpendicular to the first horizontal direction Y.

In the illustrated embodiments, the terminal is an integral stamped part.

In another exemplary embodiment of the present invention, an electrical connection assembly is also disclosed. The electrical connection assembly includes a circuit board 6 and the terminal shown in the drawings as described above; the terminal is fixed to the circuit board 6. The horizontal plate 1 of the terminal is suspended above and parallel to the circuit board 6 by the first elastic arm 3 and the second elastic arm 3′.

In an embodiment, a hole is formed in the circuit board 6, and the fixing pin 4 of the terminal is inserted into the hole of the circuit board 6 to fix and electrically connect the terminal to the circuit board 6.

As shown in FIG. 1, in the illustrated embodiments, an opening 101 is formed in the horizontal plate 1 of the terminal that allows the mating plug 5 to pass through, and a slot 601 is formed in the circuit board 6 that allows the mating plug 5 to pass through, as shown in FIG. 4.

In the illustrated embodiments, the electrical connection assembly further includes the mating plug 5, which is inserted into the terminal to be electrically connected to the terminal.

In the illustrated embodiments, the electrical connection assembly comprises multiple terminals arranged in an array on the circuit board 6. The electrical connection assembly includes multiple mating plugs 5, which are suitable for simultaneously and respectively inserting into multiple terminals.

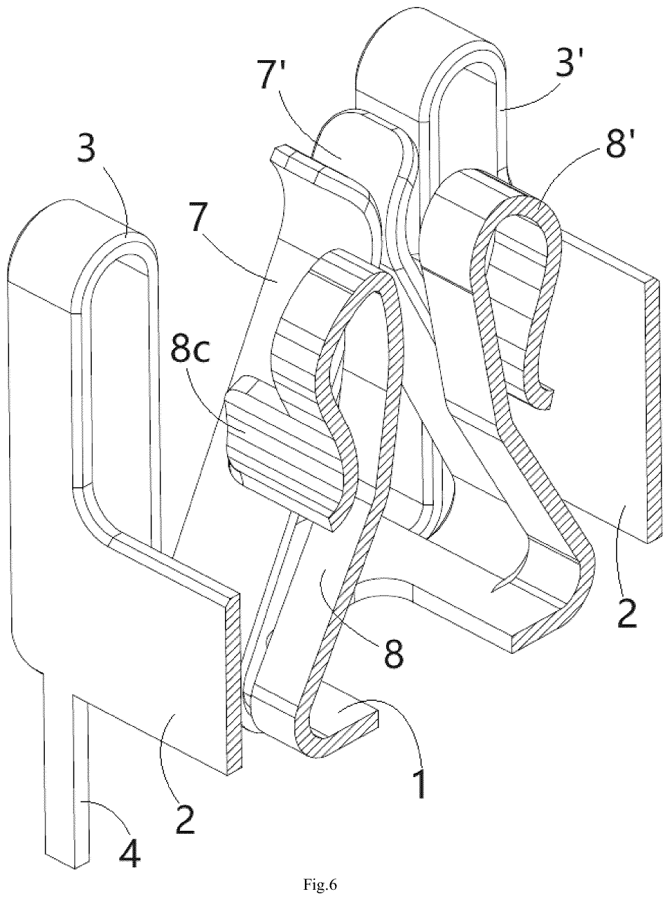

FIGS. 5 to 8 show terminals according to a second embodiment of the present invention. The terminal includes a horizontal plate 1, a pair of vertical plates 2 and 2′, a first elastic arm 3, a second elastic arm 3′, a pair of contact cantilevers 7 and 7′, and a pair of pressing cantilevers 8 and 8′. The horizontal plate 1 has a first side edge and a second side edge that are opposite to each other in a first horizontal direction Y.

The pair of vertical plates 2 and 2′ are arranged at both sides of the horizontal plate 1 and adapted to be fixed to a circuit board 6. The first elastic arm 3 is connected between the first side edge of the horizontal plate 1 and one vertical plate 2. The second elastic arm 3′ is connected between the second side edge of horizontal plate 1 and the other vertical plate 2′. The pair of contact cantilevers 7 and 7′ are connected to the first and second side edges of horizontal plate 1, respectively, for clamping the mating plug 5 inserted between them. The pair of pressing cantilevers 8 and 8′ are respectively connected to the first and second side edges of the horizontal plate 1. The pair of pressing cantilevers 8 and 8′ are pressed against the outer sides of the pair of contact cantilevers 7 and 7′, respectively, to increase the contact pressure between the pair of contact cantilevers 7 and 7′ and the mating plug 5. In the illustrated embodiment, when the pair of vertical plates 2 and 2′ are fixed to the circuit board 6, the horizontal plate 1 is suspended above the circuit board 6 by the first and second elastic arms 3 and 3′.

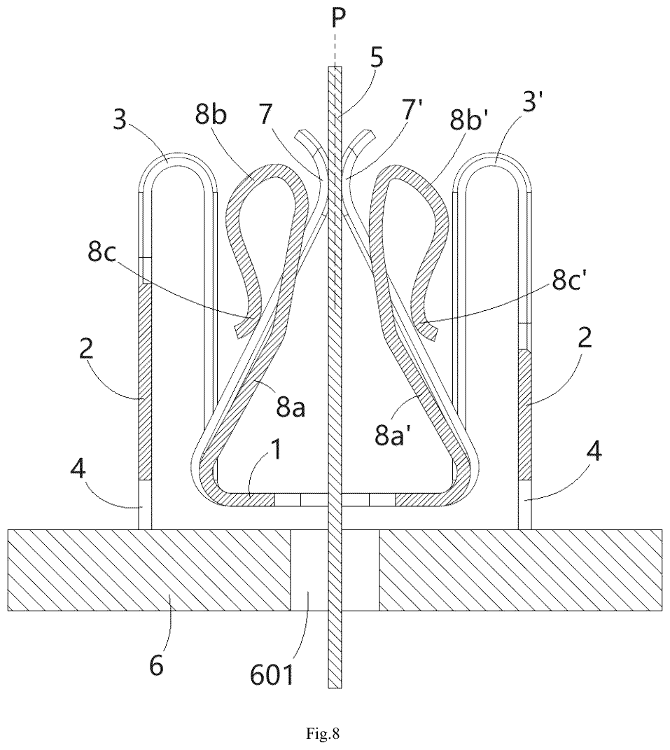

As shown in FIG. 8, in the illustrated embodiment, the terminal has a vertical symmetry plane P, which extends along a second horizontal direction X and a vertical direction Z that are perpendicular to the first horizontal direction Y. The pair of vertical plates 2 and 2′ are symmetrically arranged at both sides of the vertical symmetry plane P, and the first elastic arm 3 and the second elastic arm 3′ are symmetrically arranged at both sides of the vertical symmetry plane P. The pair of contact cantilevers 7 and 7′ are symmetrically arranged at both sides of the vertical symmetry plane P, while the pair of pressure cantilevers 8 and 8′ are symmetrically arranged at both sides of the vertical symmetry plane P.

As shown in FIGS. 5 to 8, in the illustrated embodiments, the vertical plates 2 and 2′ each has an upper side edge and a lower side edge opposite to each other in the vertical direction Z perpendicular to the first horizontal direction Y. The first elastic arm 3 is bent into a U-shape and two ends of which are respectively connected to the upper side edge of one vertical plate 2 and the first side edge of the horizontal plate 1. The second elastic arm 3′ is bent into a U-shape and two ends of which are respectively connected to the upper side edge of the other vertical plate 2′ and the second side edge of the horizontal plate 1.

As shown in FIGS. 5 to 8, in the illustrated embodiments, the terminal includes a pair of first elastic arms 3 and a pair of second elastic arms 3′, the pair of contact arms 7 and 7′ includes a pair of first contact arms 7 and a pair of second contact arms 7′, and the pair of pressing arms 8 and 8′ includes a first pressing arm 8 and a second pressing arm 8′. The pair of first contact cantilevers 7 are located between the pair of first elastic arms 3, and the pair of first pressing cantilevers 8 are located between the pair of first contact cantilevers 7. The pair of second contact cantilevers 7′ is located between the pair of second elastic arms 3′, and the pair of second pressing cantilevers 8′ is located between the pair of second contact cantilevers 7′.

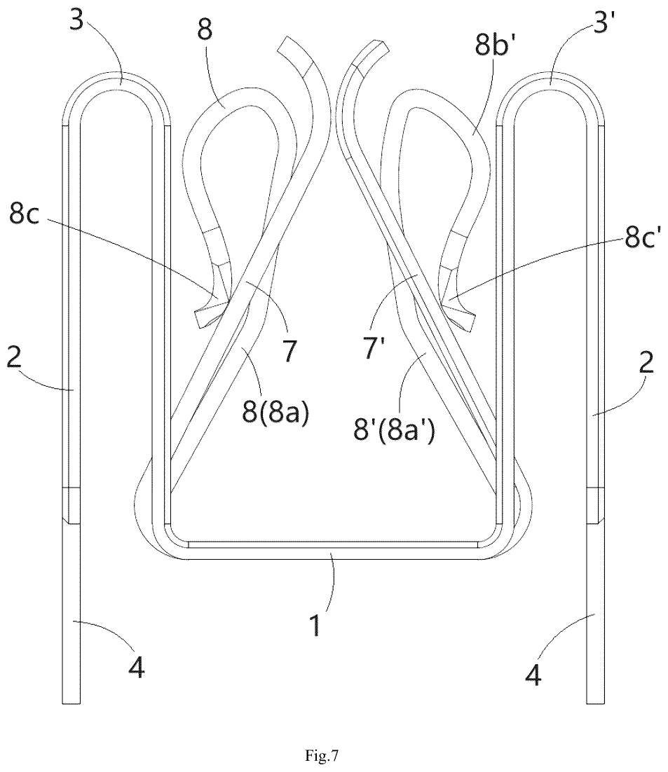

As shown in FIGS. 7 and 8, in the illustrated embodiment, the first pressing cantilever 8 includes a first extension portion 8a and a first bent portion 8b. The first extension 8a is connected to the first side edge of the horizontal plate 1 and extends diagonally upwards from the horizontal plate 1. The first bent portion 8b is connected to the first extension portion 8a and bent into a hook shape, with the end of the first bent portion 8b resting against the outer side of the first contact cantilever 7.

As shown in FIGS. 7 and 8, in the illustrated embodiment, the second pressing cantilever 8′ comprises a second extension portion 8a′ and a second bent portion 8b′. The second extension 8a′ is connected to the second side edge of the horizontal plate 1 and extends diagonally upwards from the horizontal plate 1. The second bent portion 8b′ is connected to the second extension portion 8a′ and bent into a hook shape, with the end of the second bent portion 8b′ resting against the outer side of the second contact cantilever 7′.

In the illustrated embodiments, a root of the first pressing cantilever 8 is connected to the first side edge of the horizontal plate 1, and a first pressing portion 8c is formed at the end of the first pressing cantilever 8. The two ends of the first pressing portion 8c are respectively pressed against the outer side of the pair of first contact cantilevers 7. The root of the second pressing cantilever 8′ is connected to the second side edge of the horizontal plate 1, and a second pressing portion 8c′ is formed at the end of the second pressing cantilever 8′. The two ends of the second pressing portion 8c′ are respectively pressed against the outer side of the pair of second contacting cantilevers 7′.

In the illustrated embodiment, the root of the first contact cantilever 7 is connected to the first side edge of the horizontal plate 1, and the first contact cantilever 7 extends a predetermined length inclined upwards relative to the horizontal plate 1. The root of the second contact cantilever 7′ is connected to the second side edge of the horizontal plate 1, and the second contact cantilever 7′ extends a predetermined length inclined upwards relative to the horizontal plate 1. The ends of the first contact cantilever 7 and the second contact cantilever 7′ are used for electrical contact with both sides of the inserted mating plug 5.

As shown in FIG. 5, in the illustrated embodiment, the first side edge of the horizontal plate 1 and the upper side edge of one vertical plate 2 are separated by a first distance in the first horizontal direction Y and a second distance in the vertical direction Z. The second side edge of the horizontal plate 1 and the upper side edge of the other vertical plate 2′ are separated by a first distance in the first horizontal direction Y and a second distance in the vertical direction Z.

As shown in FIGS. 5 to 8, in the illustrated embodiments, the terminal further comprises a plurality of fixing pins 4. The fixing pins 4 are formed on the lower edges of vertical plates 2 and 2′ and are suitable for being respectively fixed into multiple holes formed in the circuit board 6 for electrical connection with the circuit board 6.

In the illustrated embodiment, the terminal is an integral stamped part.

In another exemplary embodiment of the present invention, an electrical connection assembly is also disclosed. The electrical connection assembly includes a circuit board 6 and the terminal shown and described above; the terminal is fixed to the circuit board 6. The horizontal plate 1 of the terminal is suspended above and parallel to the circuit board 6 by the first elastic arm 3 and the second elastic arm 3′.

In an embodiment, a hole is formed in the circuit board 6, and the fixing pin 4 of the terminal is inserted into the hole of the circuit board 6 to fix and electrically connect the terminal to the circuit board 6.

As shown in FIG. 5, in the illustrated embodiments, an opening 101 is formed in the horizontal plate 1 of the terminal that allows the mating plug 5 to pass through, and a slot 601 is formed in the circuit board 6, as shown in FIG. 8, that allows the mating plug to pass through.

As shown in FIG. 8, in the illustrated embodiments, the electrical connection assembly further includes a mating plug 5, which is inserted into the terminal to be electrically connected to the terminal.

In the illustrated embodiments, the electrical connection assembly comprises a plurality of terminals arranged in an array on the circuit board 6. The electrical connection assembly includes multiple mating plugs 5, which are suitable for simultaneously and respectively inserting into multiple terminals.

In the aforementioned exemplary embodiments of the present invention, the first and second elastic arms of the terminal can absorb the installation position error of the terminal, allowing the terminal to float over a large range, reducing the mating difficulty between the terminal and the mating plug, and not increasing the cost.

In addition, in some exemplary embodiments according to the present invention, the first and second elastic arms of the terminal can be directly in electrical contact with the mating plug, thereby increasing the contact pressure between the terminal and the mating plug and improving the electrical contact performance of the terminal.

In addition, in some exemplary embodiments according to the present invention, the terminal has a pressing cantilever pressed on the contact cantilever, thereby increasing the contact pressure between the contact cantilever and the mating plug, and improving the electrical contact performance of the terminal.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a horizontal plate having a first side and a second side opposite to each other in a first horizontal direction;
a first elastic arm, a first end of the first elastic arm is connected to a first side edge of the horizontal plate and a second end of the first elastic arm is fixed to a circuit board; and
a second elastic arm, a first end of the second elastic arm is connected to a second side edge of the horizontal plate and a second end of the second elastic arm is fixed to the circuit board, the first elastic arm and the second elastic arm grip a mating plug inserted between them to make electrical contact with the mating plug, the horizontal plate is suspended above the circuit board by the first elastic arm and the second elastic arm.

2. The terminal according to claim 1, wherein the terminal has a vertical symmetry plane extending along a second horizontal direction and a vertical direction that are perpendicular to the first horizontal direction, the first elastic arm and the second elastic arm are symmetrically arranged at sides of the vertical symmetry plane.

3. The terminal according to claim 1, wherein the first elastic arm has a first contact arm bent into a V-shape, a first end of the first contact arm is connected to the first side edge of the horizontal plate, the second elastic arm has a second contact arm bent into a V-shape, a first end of the second contact arm is connected to the second side edge of the horizontal plate, the first contact arm and the second contact arm grip the mating plug for electrical contact with a pair of sides of the mating plug.

4. The terminal according to claim 3, wherein the first elastic arm has a first connection arm, the first connection arm is bent into a U-shape and a first end of the first connection arm is connected to a second end of the first contact arm, the second elastic arm has a second connection arm, the second connection arm is bent into a U-shape and a first end of the second connection arm is connected to a second end of the second contact arm, a second end of the first connection arm and a second end of the second connection arm are interconnected with each other and connect to the circuit board.

5. The terminal according to claim 4, wherein, when the mating plug is not inserted between the first contact arm and the second contact arm, the first contact arm is not in contact with the first connection arm, and the second contact arm is not in contact with the second connection arm, and when the mating plug is inserted centrally between the first contact arm and the second contact arm, the first contact arm contacts the first connection arm, and the second contact arm contacts the second connection arm.

6. The terminal according to claim 4, wherein, when the mating plug is not inserted between the first contact arm and the second contact arm, the first contact arm contacts the first connection arm and the second contact arm contacts the second connection arm.

7. The terminal according to claim 4, wherein, when the mating plug is inserted centrally between the first contact arm and the second contact arm, the first contact arm does not come into contact with the first connection arm and the second contact arm does not come into contact with the second connection arm, and when the mating plug is biased towards the first contact arm and inserted between the first contact arm and the second contact arm, the first contact arm contacts the first connection arm and the second contact arm does not contact the second connection arm, and when the mating plug is biased towards the second contact arm and inserted between the first contact arm and the second contact arm, the first contact arm is not in contact with the first connection arm and the second contact arm is in contact with the second connection arm.

8. The terminal according to claim 1, further comprising a plurality of fixing pins that are formed at the second end of the first elastic arm and the second end of the second elastic arm and are respectively fixed into a plurality of holes formed in the circuit board for electrical connection with the circuit board.

9. The terminal according to claim 1, wherein the terminal is an integral stamped piece.

10. A terminal, comprising:
a horizontal plate having a first side and a second side opposite to each other in a first horizontal direction;
a pair of vertical plates arranged at the first side and the second side of the horizontal plate for fixing to a circuit board;
a first elastic arm connected between a first side edge of the horizontal plate and one of the vertical plates;
a second elastic arm connected between a second side edge of the horizontal plate and another of the vertical plates;
a pair of contact cantilevers respectively connected to the first side edge and the second side edge of the horizontal plate, the contact cantilevers clamp a mating plug inserted between them; and
a pair of pressing cantilevers respectively connected to the first side edge and the second side edge of the horizontal plate, a pair of ends of the pair of pressing cantilevers are respectively pressed against a pair of outer sides of the pair of contact cantilevers to increase the contact pressure between the pair of contact cantilevers and the mating plug, and when the pair of vertical plates are fixed to the circuit board, the horizontal plate is suspended above the circuit board by the first elastic arm and the second elastic arm.

11. The terminal according to claim 10, wherein the terminal has a vertical symmetry plane, extending along a second horizontal direction and a vertical direction that are perpendicular to the first horizontal direction, the pair of vertical plates are symmetrically arranged at a pair of sides of the vertical symmetry plane, the first elastic arm and the second elastic arm are symmetrically arranged at the sides of the vertical symmetry plane, the pair of contact cantilevers are symmetrically arranged at the sides of the vertical symmetry plane, and the pair of pressing cantilevers are symmetrically arranged at the sides of the vertical symmetry plane.

12. The terminal according to claim 10, wherein each of the vertical plates has an upper side edge and a lower side edge opposite to each other in a vertical direction perpendicular to the first horizontal direction, the first elastic arm is bent into a U-shape and a pair of ends of the first elastic arm are respectively connected to the upper side edge of one vertical plate and the first side edge of the horizontal plate, the second elastic arm is bent into a U-shape and a pair of ends of the second elastic arm are respectively connected to the upper side edge of the other vertical plate and the second side edge of the horizontal plate.

13. The terminal according to claim 10, wherein each of the pressing cantilevers includes:
an extension portion connected to the horizontal plate and extending obliquely upwards from the horizontal plate; and
a bent portion connected to the extension portion and bent into a hook shape, an end of the bent portion is pressed against the outer side of one of the contact cantilevers.

14. The terminal according to claim 10, wherein the first elastic arm is one of a pair of first elastic arms and the second elastic arm is one of a pair of second elastic arms, the contact cantilevers include a pair of first contact cantilevers and a pair of second contact cantilevers, the pressing cantilevers include a first pressing cantilever and a second pressing cantilever, the first contact cantilevers are between the first elastic arms, the first pressing cantilever is between the first contact cantilevers, the second contact cantilevers are between the second elastic arms, and the second pressing cantilever is between the second contact cantilevers.

15. The terminal according to claim 14, wherein a root of the first pressing cantilever is connected to the first side edge of the horizontal plate, and a first pressing portion is formed at an end of the first pressing cantilever, a pair of ends of the first pressing portion are respectively pressed against a pair of outer sides of the pair of first contact cantilevers, and a root of the second pressing cantilever is connected to the second side edge of the horizontal plate, and a second pressing portion is formed at an end of the second pressing cantilever, a pair of ends of the second pressing portion are respectively pressed against a pair of outer sides of the pair of second contact cantilevers.

16. The terminal according to claim 14, wherein a root of the first contact cantilever is connected to the first side edge of the horizontal plate, the first contact cantilever extends a predetermined length inclined upwards relative to the horizontal plate, a root of the second contact cantilever is connected to the second side edge of the horizontal plate, the second contact cantilever extends a predetermined length inclined upwards relative to the horizontal plate, a pair of ends of the first contact cantilever and the second contact cantilever electrically contact a pair of sides of the mating plug.

17. The terminal according to claim 12, further comprising a plurality of fixing pins formed on the lower side edge of the vertical plate and respectively fixed to a plurality of holes formed in the circuit board for electrical connection with the circuit board.

18. The terminal according to claim 10, wherein the terminal is an integral stamped piece.

19. An electrical connection assembly, comprising:
a circuit board; and
a terminal fixed to the circuit board, the terminal includes:
a horizontal plate having a first side and a second side opposite to each other in a first horizontal direction;
a first elastic arm, a first end of the first elastic arm is connected to a first side edge of the horizontal plate and a second end of the first elastic arm is fixed to the circuit board; and
a second elastic arm, a first end of the second elastic arm is connected to a second side edge of the horizontal plate and a second end of the second elastic arm is fixed to the circuit board, the first elastic arm and the second elastic arm grip a mating plug inserted between them to make electrical contact with the mating plug, the horizontal plate is suspended above the circuit board and parallel to the circuit board by the first elastic arm and the second elastic arm.

20. The electrical connection assembly according to claim 19, wherein the terminal is one of a plurality of terminals arranged in an array on the circuit board, and further comprising a plurality of mating plugs capable of being simultaneously respectively inserted into the terminals.
